(19) United States
(12) Patent Application Publication
(10) Pub. No.: US 2016/0189312 A1
(43) Pub. Date: Jun. 30, 2016

(54) METHOD AND SYSTEM FOR INDEXING SPEND PATTERNS OF CROSS BORDER PAYMENT CARD HOLDERS

(71) Applicant: MASTERCARD INTERNATIONAL INCORPORATED, Purchase, NY (US)

(72) Inventors: Edward M. Lee, Scarsdale, NY (US); Matt Haisley, Purchase, NY (US)

(21) Appl. No.: 14/585,240

(22) Filed: Dec. 30, 2014

(51) Int. Cl. G06Q 40/00; G06F 17/30

(52) U.S. Cl. CPC G06Q 40/12; G06F 17/30312

(57) ABSTRACT

A method and a system are provided for indexing purchasing and/or payment activities of cross border payment card holders. In particular, one or more indices are generated based on the purchasing and payment activities of the cross border payment card holders, the countries of origin of the cross border payment card holders, and the categories of merchants. Based on the one or more indices, purchasing and/or payment behavior of cross border payment card holders is assessed. The method includes retrieving a first set of information comprising payment card transaction information of a plurality of cross border payment card holders; optionally retrieving a second set of information comprising merchant information; generating one or more indices based on the first set of information and optionally the second set of information; and assessing purchasing and payment behavior of the plurality of cross border payment card holders based on the one or more indices.

### BACKGROUND OF THE DISCLOSURE

1. Field of the Disclosure

The present disclosure relates to a method and a system for indexing purchasing and payment activities of cross border payment card holders. In particular, one or more indices are generated based on the purchasing and payment activities of the cross border payment card holders, the countries of origin of the cross border payment card holders, and the categories of merchants based on merchant line(s) of business. Based on the one or more indices, purchasing and/or payment behavior of cross border payment card holders are assessed.

2. Description of the Related Art

Organizations such as tourism boards and Chambers of Commerce for cities, states and even countries have an interest in knowing, for their particular geographical area, where tourists are coming from and what they are buying. Information useful to such organizations can include, for example, where tourists are coming from; whether tourists are spending more or less in a particular area/place/industry in comparison to a competing area/place/industry and if so, how much; what tourists are spending on including which industries and merchants; when tourists are buying and what times tourists are buying; whether there is seasonality involved with the tourist trade in a particular geographical area; and the like.

With such information, a tourism board or Chamber of Commerce, for example, can gear advertising towards certain countries to increase tourist flow and transactions. For appealing to potential tourists from the most popular countries of origin, an organization can enhance the tourist experience with staff (e.g., staff rangers) and associated language, customs, food, brochures, and the like, for those particular popular countries. Also, such information would allow organizations to plan according to tourist arrival seasonality at a particular tourist destination site. For example, if the tourist destination site is closed in May, and yet May has the most tourists entering the country or region, then the tourist destination site schedule can be adjusted.

Promoting and marketing expenses are often one of the largest cost categories for an organization. Promoting and marketing difficulties in effectively capturing and reaching the correct population of tourists, is an industry wide challenge, regardless of tourist destination sites or the goods or services offered. In an attempt to overcome these difficulties, entities often engage in various promoting and advertising techniques to a broad tourist audience hoping to reach interested tourists. However, such broad promoting and advertising techniques are often ignored by potential tourists, or fail to reach the intended tourist audience.

Information on potential tourists can be very important to promoters of tourist destinations and to sellers of goods and services. Promoters and advertisers benefit from having detailed information about buying interests or capacities of potential purchasers of goods or services. If a promoter or an advertiser, for instance, can identify and selectively promote or advertise to those potential tourists who fit a profile of probable purchasers of the promoter's or advertiser's goods or services, the promoter or advertiser can reduce advertising costs by advertising directly to those potential tourists. In other words, if the promoter or advertiser has both information about potential tourists and more targeted access for its messages, it can achieve more purchasers/customers for the same amount of money. Useful financial and demographic information for such a strategy includes a potential tourist's financial status, age, residence, and interests in various goods and services.

If a promoter or an advertiser has access to such financial and demographic information about a potential tourist, the promoter or advertiser can selectively market to the more promising tourists for a decreased expense per sales transaction. The money saved by the promoter or advertiser can, potentially, be used to reduce the price of the good or service to the tourist. Instead of advertising to the masses of potential tourists, the promoter or advertiser can concentrate on specific potential tourists who may be likely to travel to a particular destination site or to buy a specific good or service and offer favorable pricing.

Using relevant data, tourist activities and characteristics typically provide an effective form of targeted marketing by creating an experience that is personalized and relevant to the tourist. However, targeted promoting and marketing systems are often limited to accessing only a specific set of data that provides less than a holistic view of a tourist's travel preferences or spending habits and preferences.

Businesses and merchants are constantly seeking ways to operate in an environment where they are able to deliver promotional and advertising messages and offers to their target audience at the opportune time. For many, the best time for reaching potential tourists is at a time when the potential tourist is online website browsing for travel opportunities. At other times, the most ideal scenario for a tourist to receive advertisements and offers is when they are physically at the destination. In such instances, there is a need to provide targeted advertising messages and offers to tourists at the right place, to enhance the sale of goods and services to potential tourists.

Therefore, a need exists for a system that can provide a more effective form of targeted promoting or marketing by creating an experience that is more personalized and relevant to the tourist. A more holistic view of a tourist's personal circumstances, including spending habits, country of origin and associated language, customs, food and brochures, is needed for effective promoting and targeted marketing. Further, a need exists for a system that can analyze a tourist's personal circumstances and identify tourist activities and circumstances that may represent an opportunity for a merchant to offer products or services to the tourist, that are specifically tailored to the tourist's upcoming need or desire and communicate the offers to the tourist.

### SUMMARY OF THE DISCLOSURE

The present disclosure provides a method and a system for indexing purchasing and payment activities of cross border payment card holders. In particular, one or more indices are generated based on the purchasing and payment activities of the cross border payment card holders, the countries of origin of the cross border payment card holders, and the categories of merchants based on merchant line of business. Based on the one or more indices, purchasing and/or payment behavior of cross border payment card holders are assessed.

The present disclosure provides a method that includes retrieving from one or more databases a first set of information comprising payment card transaction information of a plurality of cross border payment card holders; optionally retrieving from one or more databases a second set of information comprising merchant information; generating one or more indices based on the first set of information and optionally the second set of information; and assessing purchasing and payment behavior of the plurality of cross border payment card holders based on the one or more indices.

The present disclosure also provides a system that includes one or more databases configured to store a first set of information comprising payment card transaction information of a plurality of cross border payment card holders; and optionally one or more databases configured to store a second set of information comprising merchant information. The system also includes a processor configured to: generate one or more indices based on the first set of information and optionally the second set of information; and assess purchasing and/or payment behavior of the plurality of cross border payment card holders based on the one or more indices.

The present disclosure further provides a method for generating one or more predictive behavioral models. The method involves retrieving from one or more databases a first set of information comprising payment card transaction information of a plurality of cross border payment card holders; retrieving from one or more databases a second set of information comprising merchant information; generating one or more indices based on the first set of information and the second set of information; extracting information related to an intent of the plurality of cross border payment card holders based on the one or more indices; and generating one or more predictive behavioral models based on the one or more indices and the intent of the plurality of cross border payment card holders. The plurality of cross border payment card holders have a propensity to carry out certain activities based on the one or more predictive behavioral models.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 shows illustrative information types used in the systems and the methods of the present disclosure.

FIG. 4 shows illustrative merchants in selected industry categories in accordance with exemplary embodiments of the present disclosure.

FIG. 5 illustrates an exemplary dataset for the storing, reviewing, and/or analyzing of information used in the systems and the methods of the present disclosure.

FIG. 6 is a block diagram illustrating a method for conveying suggestions or recommendations to an entity based on indices in accordance with exemplary embodiments of the present disclosure.

FIG. 7 illustrates an exemplary data set from which indices are generated, in particular, average spend per year of a cross border payment card holder indexed to average spend per year of all cross border payment card holders, in accordance with exemplary embodiments of the present disclosure.

FIG. 8 illustrates an exemplary data set from which spend in merchant categories is generated in accordance with exemplary embodiments of the present disclosure.

FIG. 9 shows the amount (% spend) of total of cross border payment card holder purchasing and payment activity in a merchant category based on a single cross border country that has been indexed to the total amount (%) of cross border payment card holder purchasing and payment activity in a merchant category based on all cross border countries, in accordance with exemplary embodiments of the present disclosure.

FIG. 10 is a block diagram illustrating a method for generating one or more predictive behavioral models in accordance with exemplary embodiments of the present disclosure.

A component or a feature that is common to more than one drawing is indicated with the same reference number in each drawing.

### DESCRIPTION OF THE PREFERRED EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, “cross border payment card holders” refers to payment card holders having a country of origin different from the country in which a payment card transaction is conducted. For example, a Canadian payment card holder that conducts a payment card transaction at a tourist destination site in the United States is a cross border payment card holder.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information (e.g., cross border payment card holder information country of origin, transaction amount, and the like) of a plurality of cross border payment card holders, and optionally retrieving from one or more databases a second set of information comprising merchant information (e.g., categories of merchants, and the like). One or more indices are generated based on the first set of information and optionally the second set of information. Purchasing and/or payment behavior of the plurality of cross border payment card holders are assessed based on the one or more indices.

Among many potential uses, the systems and methods described herein can be used to: (1) allow a tourist site or Chamber of Commerce, for example, to gear advertising towards certain countries to increase tourist flow and transactions; (2) allow an organization to enhance the tourist experience with staff (e.g., staff rangers) and associated language, customs, food, brochures, and the like, for the most popular countries of origin of tourists for a particular destination; (3) allow organizations to plan according to tourist arrival seasonality at a particular tourist destination site (e.g., if the tourist destination site is closed in May, and yet May has the most tourists entering the country or region, then the tourist destination site schedule can be adjusted); and (4) allow entities to better target tourists or customers and/or enhance existing tourist or customer relationships. Other uses are possible.

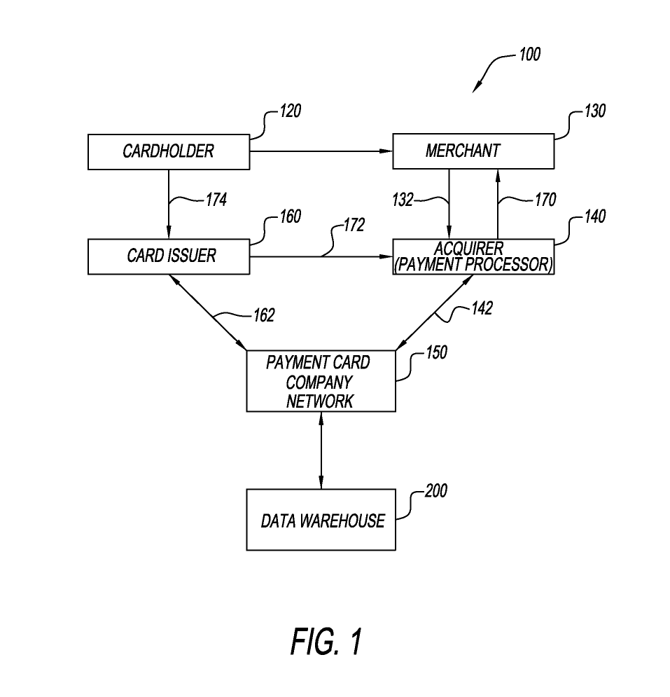

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) generating one or more indices based on the payment card transaction information of a plurality of cross border payment card holders and optionally merchant information, (ii) assessing purchasing and payment behavior of the plurality of cross border payment card holders based on the one or more indices, and (iii) generating one or more predictive behavioral models based on the one or more indices and intent of the plurality of cross border payment card holders.

In still another embodiment, data warehouse 200 stores, reviews, and/or analyzes information used in creating one or more datasets to store information relating to (i) one or more indices based on the payment card transaction information of a plurality of cross border payment card holders and optionally merchant information, (ii) purchasing and payment behavior of the plurality of cross border payment card holders based on the one or more indices, and (iii) one or more predictive behavioral models based on the one or more indices and intent of the plurality of cross border payment card holders.

In another embodiment, data warehouse 200 stores, reviews, and/or analyzes information used in developing logic for (i) generating one or more indices based on the payment card transaction information of a plurality of cross border payment card holders and optionally merchant information, (ii) assessing purchasing and payment behavior of the plurality of cross border payment card holders based on the one or more indices, and (iii) generating one or more predictive behavioral models based on the one or more indices and intent of the plurality of cross border payment card holders.

In still another embodiment, data warehouse 200 stores, reviews, and/or analyzes information used in quantifying the strength of the (i) one or more indices based on the payment card transaction information of a plurality of cross border payment card holders and optionally merchant information, (ii) purchasing and payment behavior of the plurality of cross border payment card holders based on the one or more indices, and (iii) one or more predictive behavioral models based on the one or more indices and intent of the plurality of cross border payment card holders.

In another embodiment, data warehouse 200 stores, reviews, and/or analyzes information, with respect to the (i) one or more indices based on the payment card transaction information of a plurality of cross border payment card holders and optionally merchant information, and (ii) one or more predictive behavioral models based on the one or more indices and intent of the plurality of cross border payment card holders, used in assigning attributes to the one or more cross border payment card holder purchase behaviors and the one or more categories of merchants. The attributes are selected from one or more of confidence, time, and frequency.

In still another embodiment, data warehouse 200 stores, reviews, and/or analyzes information used in targeting information including at least one or more suggestions or recommendations for an entity, based on the one or more indices.

In another embodiment, data warehouse 200 aggregates the information by cross border payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

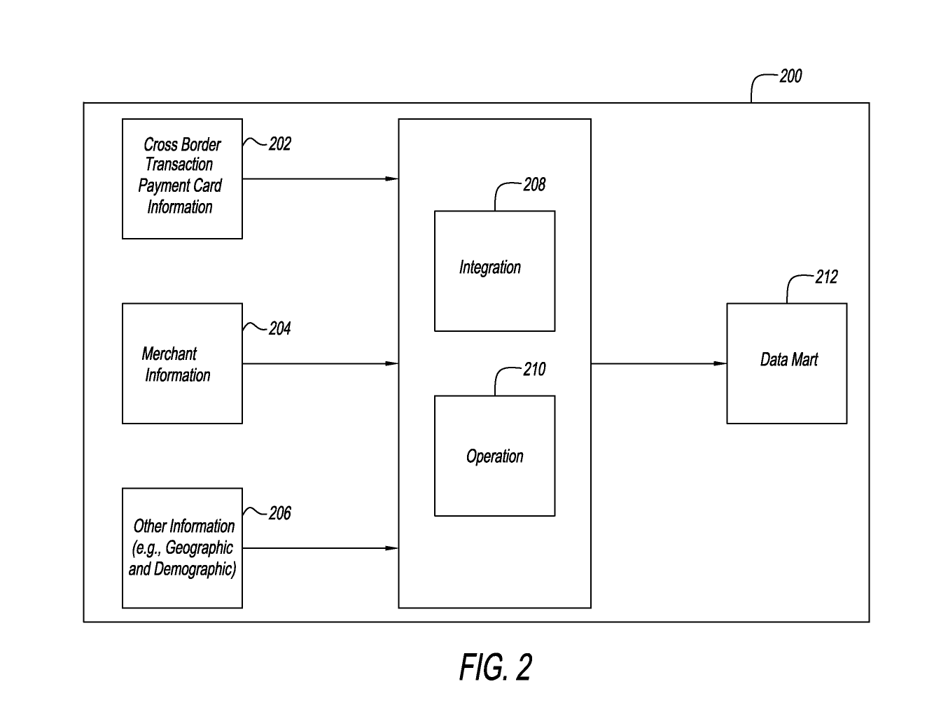

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202 and 204).

The cross border transaction payment card information 202 can contain, for example, cross border payment card transaction information, cross border payment card holder information, and purchasing and payment activities attributable to cross border payment card holders, that can be aggregated by cross border payment card holder, country of origin of cross border payment card holder, category and/or location in the data warehouse 200. The cross border transaction payment card information 202 can also contain, for example, a transaction identifier, geolocation of payment card transaction, geolocation date on which payment card transaction occurred, geolocation time on which payment card transaction occurred, and the like.

The merchant information 204 can contain, for example, categories of merchants, and the like. The merchant information 204 can also contain, for example, a merchant identifier, geolocation of merchant, and the like.

The other information 206 includes, for example, geographic data, firmographic data, and demographic data. The other information 206 can include other suitable information that can be useful in generating one or more indices based on the payment card transaction information of a plurality of cross border payment card holders and optionally merchant information, assessing purchasing and payment behavior of the plurality of cross border payment card holders based on the one or more indices, and generating one or more predictive behavioral models based on the one or more indices and intent of the plurality of cross border payment card holders.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the cross border payment card transaction information 202 can be aggregated by merchant, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

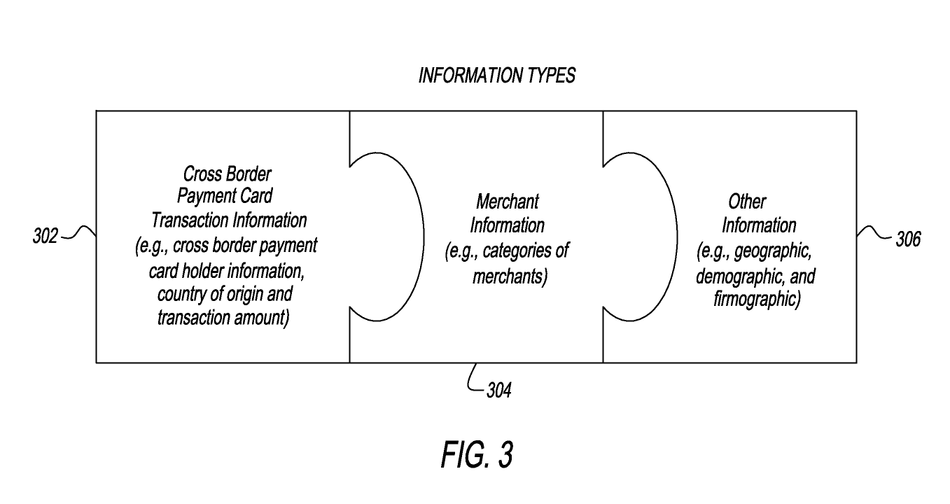

In accordance with the method of this disclosure, information that is stored in one or more databases can be retrieved (e.g., by a processor). FIG. 3 shows illustrative information types used in the systems and methods of this disclosure.

The information can contain, for example, a first set of information 302 that can be retrieved from one or more databases owned or controlled by an entity, for example, a payment card company (part of the payment card company network 150 in FIG. 1). The cross border transaction payment card information 302 can contain, for example, cross border payment card transaction information, cross border payment card holder information (e.g., payment card holder account identifier (likely anonymized), payment card holder geography (potentially modeled), payment card holder type (consumer/business), payment card holder demographics, and the like), and purchasing and payment activities attributable to cross border payment card holders, that can be aggregated by cross border payment card holder, country of origin of cross border payment card holder, category and/or location, transaction date and time, and transaction amount. The cross border transaction payment card information 302 can also contain, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 304 can contain, for example, categories of merchants, merchant name, merchant geography, merchant line of business, and the like. The merchant information 304 can also contain, for example, a merchant identifier, geolocation of merchant, and the like.

One or more databases are used for storing information of one or more merchants, and merchants belonging to a particular category, e.g., industry category. Illustrative merchant categories are described herein. The merchant categorization is useful for generating one or more indices and one or more predictive behavioral models based on the one or more indices and intent of the plurality of cross border payment card holders.

In an embodiment, a merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of generating one or more indices and one or more predictive behavioral models based on the one or more indices and intent of the plurality of cross border payment card holders, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). In one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photo finishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

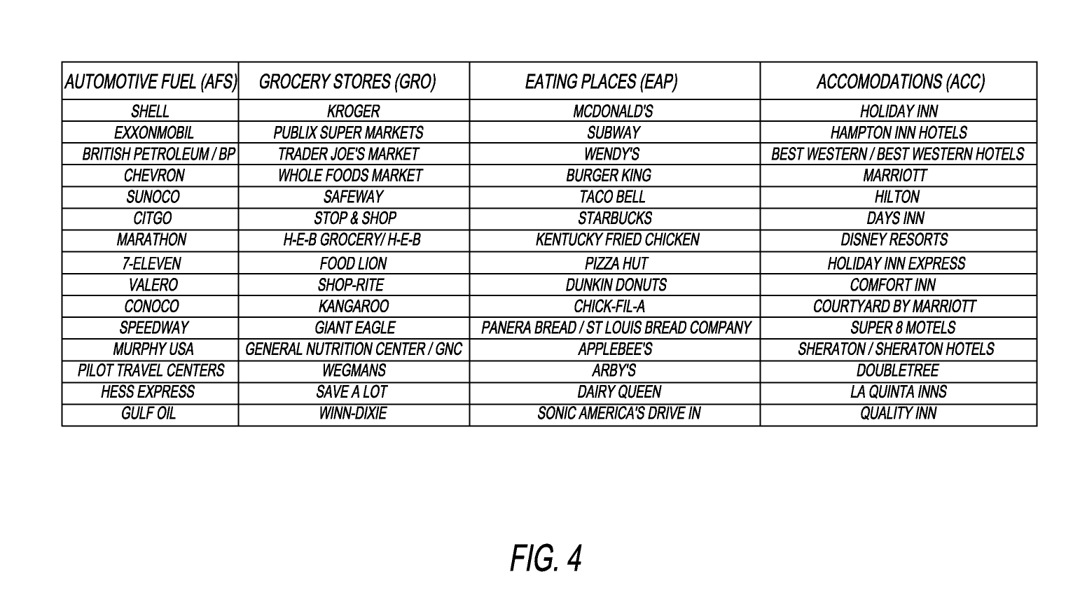

Illustrative merchants and industry categorization are shown in FIG. 4. The illustrative industry categories include AFS Automotive Fuel, GRO Grocery Stores, EAP Eating Places, and ACC Accommodations. Illustrative merchants associated with the industry categories are listed in FIG. 4. In accordance with this disclosure, merchant categorization is important for indexing purchasing and payment activities of cross border payment card holders. Proper merchant categorization is important to obtain indexing results that are truly reflective of the particular merchant and industry, in particular, to determine how purchasing and payment activities of cross border payment card holders is trending for one merchant in comparison to another merchant in the same industry category.

Also, the information can optionally contain, for example, a third set of information including other information 306. Illustrative third set information can include, for example, geographic data, firmographic data, demographic data, and the like. In particular, the third set of information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The third set of information affords leveraged data sources that can supplement information in the first set of information and the second set of information.

The other information 306 can further include firmographics data, for example, line of operations for a business, information related to employees, revenues and industries, and the like. In particular, the firmographics data relates to information on merchants that is typically used in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing in a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Merchant payment trend information can include, for example, information that spots trends in a merchant's business by analyzing how it pays its bills.

Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Merchant public filing information can include, for example, bankruptcy filings, suits, liens, and judgment information obtained from Federal and State court houses for a company.

Demographic information can also be used to supplement or leverage the first set of information and the second set of information. Illustrative demographic information includes, for example, age, income, presence of children, education, and the like.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific index is retrieved from each of the databases.

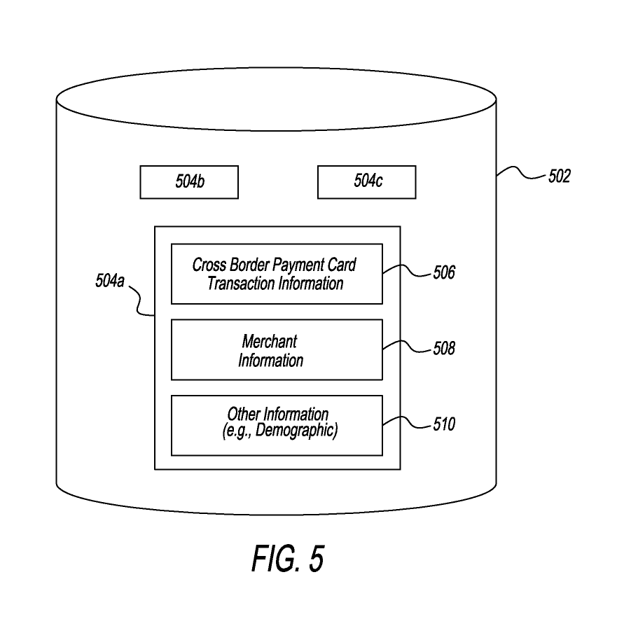

Referring to FIG. 5, an exemplary dataset 502 stores, reviews, and/or analyzes of information used in the systems and methods of this disclosure. The dataset 502 can contain a plurality of entries (e.g., entries 504a, 504b, and 504c).

The cross border payment card transaction information 506 includes payment card transactions and actual spending by cross border payment card holders. More specifically, cross border payment card transaction information 506 can include, for example, cross border payment card transaction information, transaction date and time, transaction amount, cross border payment card holder information (e.g., cross border payment card holder account identifier (likely anonymized), cross border payment card holder geography (potentially modeled), cross border payment card holder type (consumer/business), cross border payment card holder demographics, and the like), and purchasing and payment activities attributable to cross border payment card holders, that can be aggregated by cross border payment card holder, country of origin of cross border payment card holder, category and/or location, transaction date and time, and transaction amount. The cross border transaction payment card information 506 can also contain, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 508 can contain, for example, categories of merchants, merchant name, merchant geography, merchant line of business, and the like. The merchant information 508 can also contain, for example, a merchant identifier, geolocation of merchant, and the like.

The other information 510 includes, for example, geographic data, firmographic data, demographic data, and other suitable information that can be useful in conducting the systems and methods of this disclosure.

Algorithms can be employed to determine formulaic descriptions of the integration of the cross border payment card transaction information 506, merchant information 508 and optionally the other information 510 using any of a variety of known mathematical techniques. These formulas, in turn, can be used to derive or generate one or more analyses and updates using any of a variety of available trend analysis algorithms. For example, these formulas can be used to generate one or more indices based on the payment card transaction information of a plurality of cross border payment card holders and optionally merchant information, assess purchasing and payment behavior of the plurality of cross border payment card holders based on the one or more indices, and generate one or more predictive behavioral models based on the one or more indices and intent of the plurality of cross border payment card holders.

In an embodiment, logic is developed for generating one or more indices based on the payment card transaction information of a plurality of cross border payment card holders and optionally merchant information, assessing purchasing and payment behavior of the plurality of cross border payment card holders based on the one or more indices, and generating one or more predictive behavioral models based on the one or more indices and intent of the plurality of cross border payment card holders. The logic is applied to a universe of cross border payment card holders to identify travel patterns and purchasing and payment activities of the universe of payment card holders.

In accordance with the method of this disclosure, information that is stored in one or more databases can be retrieved (e.g., by a processor). The information can contain, for example, billing activities attributable to the financial transaction processing entity (e.g., a payment card company) and purchasing and payment activities, including date and time, attributable to cross border payment card holders, merchant information, demographic (e.g., age and gender), geographic (e.g., zip code and state or country of residence), and the like. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

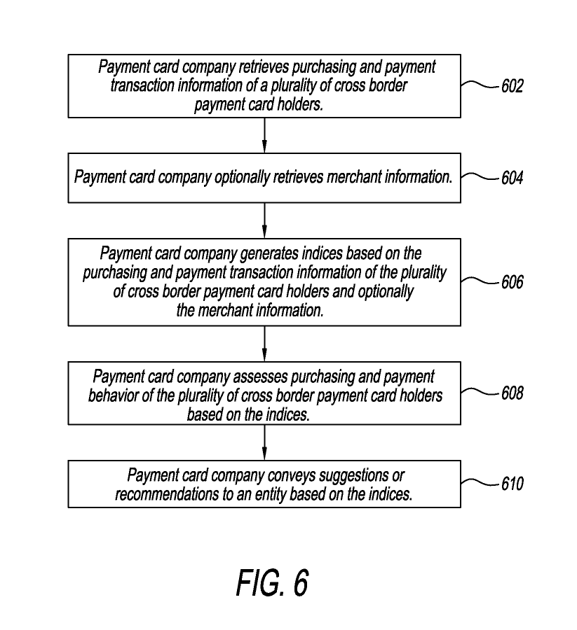

FIG. 6 illustrates an exemplary method for an entity (e.g., payment card company) conveying suggestions or recommendations to another entity (e.g., tourism board, Chamber of Commerce, merchant, and the like) based on the indices. At step 602, a payment card company (part of the payment card company network 150 in FIG. 1) retrieves, from one or more databases, information including purchasing and payment information attributable to one or more cross border payment card holders. The information at 602 includes cross border payment card transaction information, cross border payment card holder information (e.g., payment card holder account identifier (likely anonymized), payment card holder geography (potentially modeled), payment card holder type (consumer/business), payment card holder demographics, and the like), and purchasing and payment activities attributable to cross border payment card holders. The payment card company optionally retrieves, from one or more databases, at 604 merchant information. The merchant information at 604 includes categories of merchants, merchant name, merchant geography, merchant line of business, and the like. The merchant information 604 also includes, for example, a merchant identifier, geolocation of merchant, and the like. The payment card company optionally retrieves, from one or more databases, other information including demographic, firmographic and/or geographic information (not shown in FIG. 6).

In step 606, based on the first set of information and optionally the second set of information and third set of information, one or more indices are generated. The payment card company generates one or more indices based on the purchasing and payment activity information of cross border payment card holders and optionally merchant information and other information at 606, and identifies activities and characteristics attributable to potential tourists and purchasers based on the indices. Activities and characteristics attributable to the cross border payment card holders are identified based on the one or more indices. The payment card company assesses purchasing and payment behavior of the plurality of cross border payment card holders based on the indices at 608.

The payment card company conveys suggestions or recommendations to an entity at 610 to enable the entity, such as a tourism board, Chamber of Commerce or merchant, to make targeted promotions or offers to the cross border payment card holders as potential tourists. In an embodiment, the payment card company conveys to the entity at 610 a spending behavioral propensity score based on the indices. The score is indicative of a propensity of a potential tourist or purchaser to exhibit a certain behavior.

In an embodiment, the entity provides feedback to the payment card company to enable the payment card company to monitor and track impact of targeted promotions and offers. This “closed loop” system allows an entity to track promotional and advertising campaigns, measure efficiency of the targeting, and make any improvements for the next round of promotions or campaigns.

One or more algorithms can be employed to determine formulaic descriptions of the assembly of the cross border payment card holder information including cross border purchasing and payment transactions, merchant information, and optionally demographic, firmographic and/or geographic information, using any of a variety of known mathematical techniques. These formulas in turn can be used to derive or generate one or more indices using any of a variety of available trend analysis algorithms.

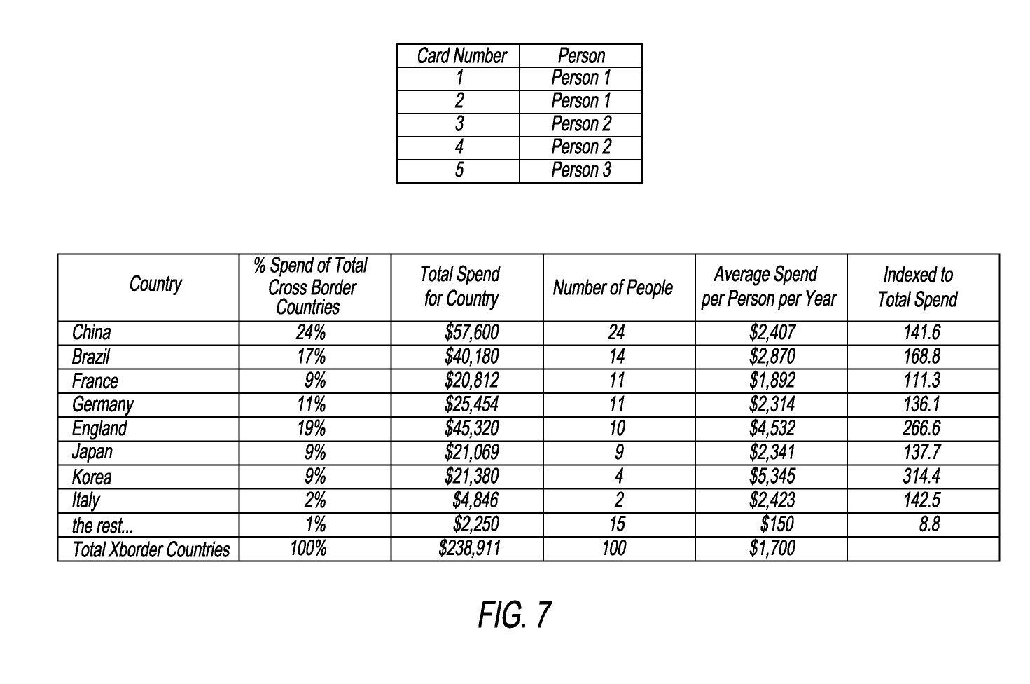

Illustrative indices generated in accordance with this disclosure are exemplified in FIGS. 7-9. One preferred index is average spend per year of a cross border payment card holder that is indexed to average spend per year of all cross border payment card holder. This is shown in FIG. 7. This index is derived by analyzing the first set of information to identify purchasing and payment activities of the plurality of cross border payment card holders, and countries of origin of the plurality of cross border payment card holders; and generating one or more indices based on the purchasing and payment activities of the plurality of cross border payment card holders, and the countries of origin of the plurality of cross border payment card holders. This index is a measure of the degree to which an average of individual cross border payment card holder purchasing and payment activity based on a single cross border country and an average of individual cross border payment card holder purchasing and payment activity based on all cross border countries are correlated for a defined time period.

FIG. 7 shows a table that identifies the number of payment cards held by a cross border payment card holder during a particular time period and at the particular tourist site. The international tourists and shoppers are from the countries listed in the table in FIG. 7. FIG. 7 shows the average amounts of individual cross border payment card holder purchasing and payment activity based on a single cross border country and the average amounts of individual cross border payment card holder purchasing and payment activity based on all cross border countries. Based on the information provided in FIG. 7, a tourism board, Chamber of Commerce or merchant may implement language based services for staffing and brochure printing and for foreign/local promotions and advertising. The indexed information from FIG. 7 shows, for example, that although there are more tourists from China, the tourists from Korea spend more per person.

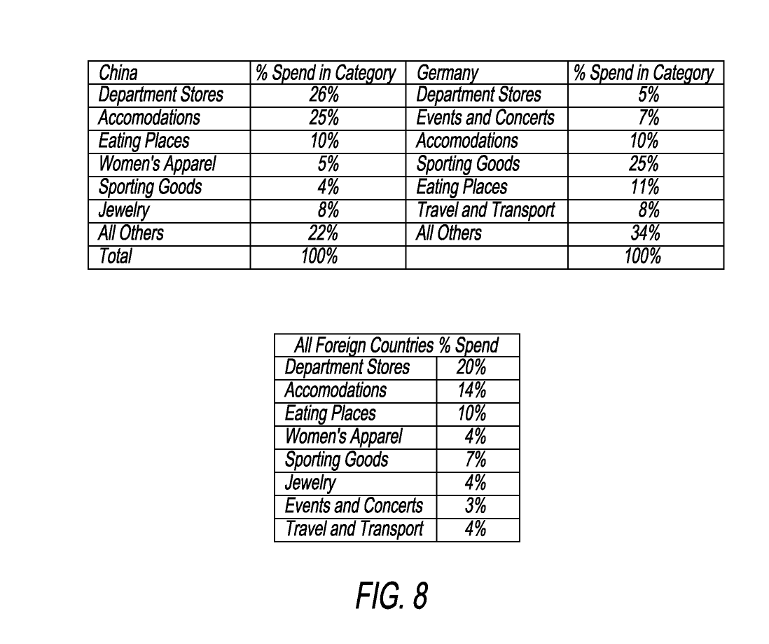

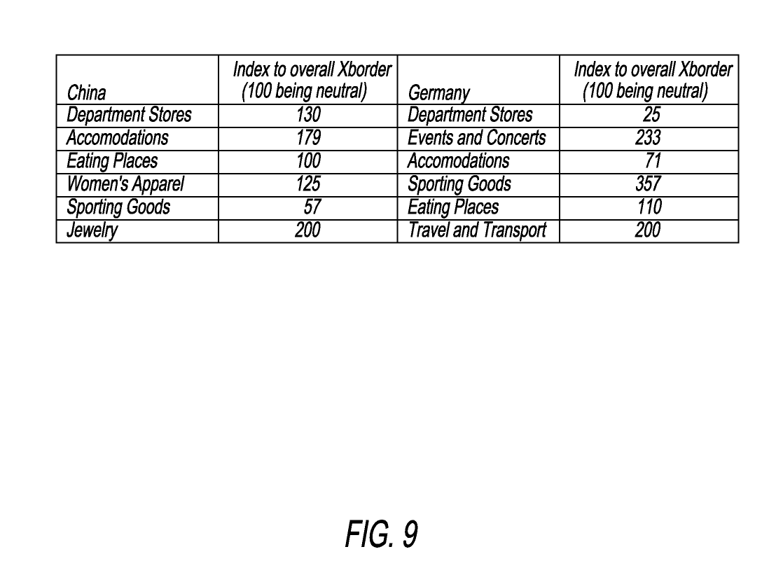

Another preferred index is total spend per year of a cross border payment card holder based on country of origin that is indexed to overall spend per year of all cross border payment card holders from all countries of origin. This is shown in FIGS. 8 and 9. This index is derived by analyzing the first set of information to identify purchasing and payment activities of the plurality of cross border payment card holders, and one or more countries of origin of the plurality of cross border payment card holders; analyzing the second set of information to identify one or more categories of merchants based on merchant line of business; and generating one or more indices based on the purchasing and payment activities of the plurality of cross border payment card holders, the countries of origin of the one or more cross border payment card holders, and the one or more categories of merchants based on merchant line of business. This index is a measure of the degree to which a total of cross border payment card holder purchasing and payment activity in a merchant category based on a single cross border country and a total of cross border payment card holder purchasing and payment activity in a merchant category based on all cross border countries are correlated for a defined time period.

FIG. 8 shows the amount (% spend) of total of cross border payment card holder purchasing and payment activity in a merchant category based on a single cross border country and the total amount (%) of cross border payment card holder purchasing and payment activity in a merchant category based on all cross border countries. Based on the information provided in FIG. 8, a tourism board, Chamber of Commerce or merchant can implement promotions or advertising in the local industries with the high spend for the particular countries. A payment card company, for example, can inform local merchants of the breakdown to help local businesses to cater to the appropriate countries.

FIG. 9 shows the amount (% spend) of total of cross border payment card holder purchasing and payment activity in a merchant category based on a single cross border country that has been indexed to the total amount (%) of cross border payment card holder purchasing and payment activity in a merchant category based on all cross border countries. Based on the information provided in FIG. 9, a tourism board, Chamber of Commerce or merchant can implement promotions or advertising in the local industries with the high spend for the particular countries. A payment card company, for example, can inform local merchants of the breakdown to help local businesses to cater to the appropriate countries.

As shown in FIG. 9, although tourists from China spend only 8% of their overseas spend on jewelry, they are twice (2×) more likely to buy jewelry than all other foreign tourists. FIG. 9 also shows that tourists from Germany spend 25% of their overseas spend on sporting goods in comparison to just 7% for all other foreign tourists. A payment card company, for example, can inform the local jewelry merchant and local sporting goods store accordingly.

The indices based on the first set of information and optionally the second set of information and the third set of information can be constructed by statistical analysis, for example, clustering, regression, correlation, segmentation, and raking. As also described herein, the indices can be algorithmically constructed based on the first set of information and optionally the second set of information and the third set of information.

In accordance with this disclosure, indexing can be used to determine where tourists are coming from; whether tourists are spending more or less in a particular area/place/industry in comparison to a competing area/place/industry and if so, how much; what tourists are spending on including which industries and merchants; when tourists are buying and what times tourists are buying; whether there is seasonality involved with the tourist trade in a particular geographical area; and the like. The indexing is based on cross border payment card holder transaction information, merchant categorization information and other information indicative of spend patterns of cross border payment card holders.

An indexing score can be used for assessing purchasing and payment behavior of the plurality of cross border payment card holders. The indexing score can be trended over time. Proper merchant categorization is important for obtaining indexing results that are truly reflective of the particular merchant and industry, in particular, for determining how cross border purchasing and payment behavior is trending for one merchant in comparison to another merchant in the same industry category.

The indexing can be updated or refreshed at a specified time (e.g., on a regular basis or upon request of a party). Updating the indexing can include updating the cross border payment card transaction data, merchant data, and optionally demographic data and/or updated geographic data. Indexing can also be updated by changing the attributes that define each merchant, and generating a different merchant categorization. The process for updating indexing can depend on the circumstances regarding the need for the information itself.

One or more algorithms can be employed to determine formulaic descriptions of the assembly of the cross border payment card transaction information, merchant categorization information, and optionally demographic and/or geographic information, using any of a variety of known mathematical techniques. These formulas in turn can be used to derive or generate indexing using any of a variety of available analysis algorithms.

In accordance with this disclosure, one or more predictive behavioral models are generated based at least in part on the first set of information and the second set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include cross border financial account information, merchant information, performing statistical analysis on cross border financial account information and merchant information, finding correlations between account information, merchant information and cross border payment card holder behaviors, predicting future cross border payment card holder behaviors based on cross border account information and merchant information, and the like.

Activities and characteristics attributable to the cross border payment card holders based on the one or more predictive behavioral models are identified. The cross border payment card holders have a propensity to carry out certain activities and to exhibit certain characteristics, based on the one or more predictive behavioral models. The activities and characteristics attributable to the cross border payment card holders and based on the one or more predictive behavioral models are conveyed by the financial transaction processing entity to the entity (e.g., tourism board, Chamber of Commerce, merchant, and the like) to take appropriate action, for example, making a targeted offer. This conveyance enables a targeted offer to be made by the entity to the cross border payment card holders. The transmittal can be performed by any suitable method as will be apparent to persons having skill in the relevant art.

Predictive behavioral models can be defined based on geographical or demographical information, including but not limited to, age, gender, income, marital status, postal code, income, spending propensity, and familial status. In some embodiments, predictive behavioral models can be defined by a plurality of geographical and/or demographical categories. For example, a predictive behavioral model can be defined for any cross border payment card holder who engages in purchasing and spending activity.

Predictive behavioral models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for spending behaviors. Results of the analysis can be assigned to the predictive behavioral models.

In an embodiment, the information retrieved from each database can be analyzed to determine behavioral information of the cross border payment card holders. Also, information related to an intention of the cross border payment card holders can be extracted from the behavioral information. The predictive behavioral models can be based upon the behavioral information of the cross border payment card holders and the intent of the cross border payment card holders. In some embodiments, the predictive behavioral models can be capable of predicting behavior and intent in the cross border payment card holders.

In analyzing information to determine behavioral information, intent and other cross border payment card holder attributes are considered. Developing intent of cross border payment card holders involves models that predict specific spend behavior at certain times in the future and desirable spend behaviors.

Predictive behavioral models can equate to purchase behaviors. There can be different degrees of predictive behavioral models with the ultimate behavior being a purchase.

The one or more predictive behavioral models are capable of predicting behavior and intent in the one or more cross border payment card holders. The one or more cross border payment card holders are people and/or businesses; the activities attributable to the one or more cross border payment card holders are purchasing and spending transactions; and the characteristics attributable to the one or more cross border payment card holders are demographics and/or geographical characteristics.

A behavioral propensity score can be used for conveying to the entity the activities and characteristics attributable to the one or more cross border payment card holders based on the one or more predictive behavioral models. The behavioral propensity score is indicative of a propensity to exhibit a certain behavior.

Potential cross border payment card holders can represent a wide variety of categories and attributes. In one embodiment, potential cross border payment card holder categories can be created based on spending propensity of spending index in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential cross border payment card holders (e.g., based on location, income groups, and the like).

A financial transaction processing company can analyze the generated predictive behavioral models (e.g., by analyzing the stored data for each entity comprising the predictive behavioral model) for behavioral information (e.g., cross border spend behaviors and propensities). In some embodiments, the behavioral information can be represented by a behavioral propensity score. Behavioral information can be assigned to each corresponding predictive behavioral model.

Predictive behavioral models or behavioral information can be updated or refreshed at a specified time (e.g., on a regular basis or upon request of a party). Updating predictive behavioral models can include updating the entities in each predictive behavioral model with updated demographic data and/or updated financial data. Predictive behavioral models can also be updated by changing the attributes that define each predictive behavioral model, and generating a different set of behaviors. The process for updating behavioral information can depend on the circumstances regarding the need for the information itself.

Although the above methods and processes are disclosed primarily with reference to financial data and cross border spending behaviors, it will be apparent to persons having skill in the relevant art that the predictive behavioral models can be beneficial in a variety of other applications. Predictive behavioral models can be useful in the evaluation of consumer data that needs to be protected.

The payment card company analyzes the first set of information and second set of information to determine behavioral information of the cross border payment card holders. The payment card company extracts information related to intent of the cross border payment card holders from the behavioral information.

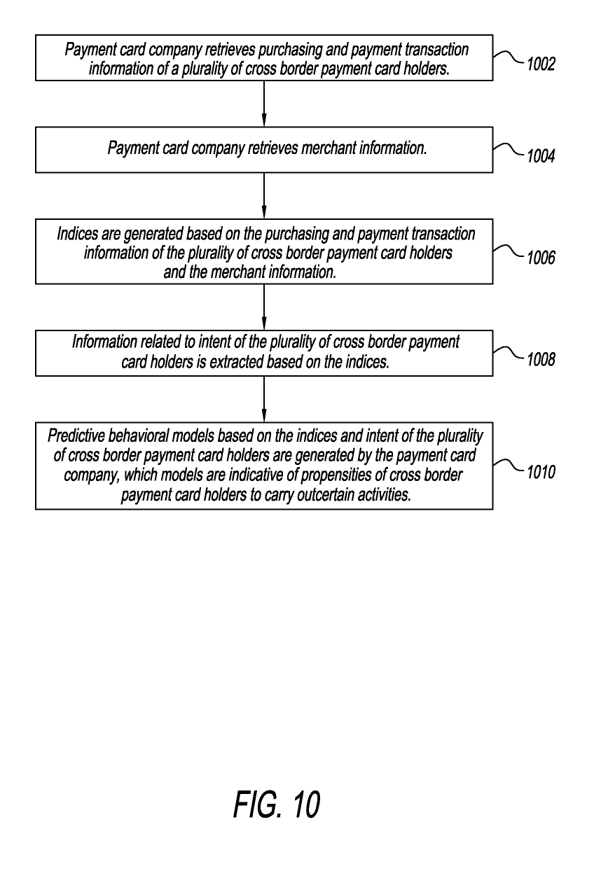

A method for generating one or more predictive behavioral models is an embodiment of this disclosure. Referring to FIG. 10, the method involves a payment card company (part of the payment card company network 150 in FIG. 1) retrieving, from one or more databases, information including activities and characteristics (e.g., purchasing and payment transaction information) attributable to one or more cross border payment card holders. The information at 1002 includes cross border payment card transaction information, cross border payment card holder information (e.g., payment card holder account identifier (likely anonymized), payment card holder geography (potentially modeled), payment card holder type (consumer/business), payment card holder demographics, and the like), and purchasing and payment activities attributable to cross border payment card holders. The payment card company optionally retrieves, from one or more databases, at 1004 merchant information. The merchant information at 1004 includes categories of merchants, merchant name, merchant geography, merchant line of business, and the like. The merchant information 1004 also includes, for example, a merchant identifier, geolocation of merchant, and the like. The payment card company optionally retrieves, from one or more databases, other information including demographic, firmographic and/or geographic information (not shown in FIG. 10).

Indices are generated at 1006 based on the purchasing and payment transaction information of the plurality of cross border payment card holders, merchant information and other information. Information related to an intent of the one or more cross border payment card holders is extracted from the indices at 1008. One or more predictive behavioral models are generated at 1010 based on the behavioral information and intent of the one or more payment card holders. The one or more cross border payment card holders have a propensity to carry out certain activities at certain times based on the one or more predictive behavioral models.

The payment card company identifies activities and characteristics attributable to cross border payment card holders (e.g., potential tourists or consumers) based on the predictive behavioral models. The activities and characteristics attributable to the cross border payment card holders based on the one or more predictive behavioral models are conveyed to an entity, to enable the entity, such as a tourism board, Chamber of Commerce or merchant, to make a promotion or targeted offer to the cross border payment card holders. In an embodiment, the payment card company conveys to the entity a behavioral propensity score based on the predictive behavioral models. The score is indicative of a propensity of a potential tourist or purchaser to exhibit a certain behavior.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications can be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information of a plurality of cross border payment card holders;
retrieving from one or more databases a second set of information comprising merchant information;
generating one or more indices based on the first set of information; and
assessing purchasing and payment behavior of the plurality of cross border payment card holders based on the one or more indices.

2. The method of claim 1, further comprising:
analyzing the first set of information to identify purchasing and payment activities of the plurality of cross border payment card holders, and countries of origin of the plurality of cross border payment card holders, and
wherein the generating of one or more indices is based on the purchasing and payment activities of the plurality of cross border payment card holders, and the countries of origin of the plurality of cross border payment card holders.

3. The method of claim 1, wherein generating the one or more indices is also based on the second set of information.

4. The method of claim 3, further comprising:
analyzing the first set of information to identify purchasing and payment activities of the plurality of cross border payment card holders, and one or more countries of origin of the plurality of cross border payment card holders;
analyzing the second set of information to identify one or more categories of merchants based on merchant line of business; and
generating one or more indices based on the purchasing and payment activities of the plurality of cross border payment card holders, the countries of origin of the one or more cross border payment card holders, and the one or more categories of merchants based on merchant line of business.

5. The method of claim 2, wherein the one or more indices are a measure of the degree to which an average of individual cross border payment card holder purchasing and payment activity based on a single cross border country and an average of individual cross border payment card holder purchasing and payment activity based on all cross border countries are correlated for a defined time period.

6. The method of claim 4, wherein the one or more indices are a measure of the degree to which a total of cross border payment card holder purchasing and payment activity in a merchant category based on a single cross border country and a total of cross border payment card holder purchasing and payment activity in a merchant category based on all cross border countries are correlated for a defined time period.

7. The method of claim 3, further comprising algorithmically generating the one or more indices based on the first set of information and the second set of information.

8. The method of claim 4, wherein the one or more categories of merchants is constructed by industry sector.

9. The method of claim 1, further comprising:
retrieving from the one or more databases a third set of information comprising other information, wherein the other information comprises geographic data, firmographic data, and demographic data.

10. The method of claim 1, further comprising creating one or more datasets to store information relating to the payment card transaction information of the plurality of cross border payment card holders; countries of origin of the plurality of cross border payment card holders; one or more categories of merchants based on merchant line of business; one or more indices based on the purchasing and payment activities of the plurality of cross border payment card holders, and the countries of origin of the plurality of cross border payment card holders; and one or more indices based on the purchasing and payment activities of the plurality of cross border payment card holders, the countries of origin of the one or more cross border payment card holders, and the one or more categories of merchants based on merchant line of business.

11. The method of claim 1, further comprising developing logic for analyzing the first set of information to identify purchasing and payment activities of the plurality of cross border payment card holders, and countries of origin of the plurality of cross border payment card holders; and generating with the developed logic one or more indices based on the purchasing and payment activities of the plurality of cross border payment card holders, and the countries of origin of the plurality of cross border payment card holders.

12. The method of claim 11, wherein the developed logic analyzes the second set of information to identify one or more categories of merchants based on merchant line of business; and the one or more indices generated is also based on the one or more categories of merchants based on merchant line of business.

13. A system comprising:
one or more databases configured to store a first set of information comprising payment card transaction information of a plurality of cross border payment card holders;
one or more databases configured to store a second set of information comprising merchant information;
a processor configured to:
generate one or more indices based on the first set of information and the second set of information; and
assess purchasing and payment behavior of the plurality of cross border payment card holders based on the one or more indices.

14. The system of claim 13, wherein the processor is configured to:
analyze the first set of information to identify purchasing and payment activities of the plurality of cross border payment card holders, and countries of origin of the plurality of cross border payment card holders, and
wherein the generated one or more indices is based on the purchasing and payment activities of the plurality of cross border payment card holders, and the countries of origin of the plurality of cross border payment card holders.

15. The system of claim 13, wherein the processor is configured to:
analyze the first set of information to identify purchasing and payment activities of the plurality of cross border payment card holders, and one or more countries of origin of the plurality of cross border payment card holders;
analyze the second set of information to identify one or more categories of merchants based on merchant line of business; and
generate one or more indices based on the purchasing and payment activities of the plurality of cross border payment card holders, the countries of origin of the one or more cross border payment card holders, and the one or more categories of merchants based on merchant line of business.

16. The system of claim 13, wherein the one or more indices are a measure of the degree to which either an average of individual cross border payment card holder purchasing and payment activity based on a single cross border country and an average of individual cross border payment card holder purchasing and payment activity based on all cross border countries are correlated for a defined time period, or a total of cross border payment card holder purchasing and payment activity in a merchant category based on a single cross border country and a total of cross border payment card holder purchasing and payment activity in a merchant category based on all cross border countries are correlated for a defined time period.

17. The system of claim 13, further comprising:
one or more databases configured to store a third set of information comprising other information, wherein the other information comprises geographic data, firmographic data, and demographic data.

18. The system of claim 13, wherein the processor is configured to develop logic for analyzing the first set of information to identify purchasing and payment activities of the plurality of cross border payment card holders, and countries of origin of the plurality of cross border payment card holders; and generate with the developed logic one or more indices based on the purchasing and payment activities of the plurality of cross border payment card holders, and the countries of origin of the plurality of cross border payment card holders.

19. A method for generating one or more predictive behavioral models, the method comprising:
retrieving from one or more databases a first set of information comprising payment card transaction information of a plurality of cross border payment card holders;
retrieving from one or more databases a second set of information comprising merchant information;
generating one or more indices based on the first set of information and the second set of information, wherein the one or more indices generated is based on the purchasing and payment activities of the plurality of cross border payment card holders, and the countries of origin of the plurality of cross border payment card holders;
extracting information related to an intent of the plurality of cross border payment card holders based on the one or more indices; and
generating one or more predictive behavioral models based on the one or more indices and the intent of the plurality of cross border payment card holders, wherein the plurality of cross border payment card holders have a propensity to carry out certain activities based on the one or more predictive behavioral models.

20. The method of claim 19, further comprising:
analyzing the first set of information to identify purchasing and payment activities of the plurality of cross border payment card holders, and one or more countries of origin of the plurality of cross border payment card holders; and
analyzing the second set of information to identify one or more categories of merchants based on merchant line of business.

21. The method of claim 20, wherein the one or more indices are a measure of the degree to which either (1) an average of individual cross border payment card holder purchasing and payment activity based on a single cross border country and an average of individual cross border payment card holder purchasing and payment activity based on all cross border countries are correlated for a defined time period, or (2) a total of cross border payment card holder purchasing and payment activity in a merchant category based on a single cross border country and a total of cross border payment card holder purchasing and payment activity in a merchant category based on all cross border countries are correlated for a defined time period.
